(19) United States
(12) Patent Application Publication
(10) Pub. No.: US 2007/0172793 A1
(43) Pub. Date: Jul. 26, 2007

(54) Dental implement for tooth restoration

(75) Inventors: Scott Doenges, West Olive, MI (US); Tom Garrison, Spring Lake, MI (US); Robert Anderson, Coopersville, MI (US); Kevin S. Walburg, Grand Haven, MI (US)

Correspondence Address: THE WATSON INTELLECTUAL PROPERTY GROUP, PLC, 3133 HIGHLAND DRIVE, SUITE 200, HUDSONVILLE, MI, 49426, US

(73) Assignee: Garrison Dental Solutions

(21) Appl. No.: 11/337,322

(22) Filed: Jan. 23, 2006

(51) Int. Cl. A61C 5/12; A61C 3/00

(52) U.S. Cl. 433/139; 433/153

(57) ABSTRACT

A dental implement comprising a primary body and a secondary body. The primary body includes a substantially planar ring shaped portion having opposing ends and a pair of tines extending in a downward direction from the opposing ends. The secondary body is formed over at least a portion of the primary body. The secondary body defines a cross-sectional area therealong. The cross-sectional area of the secondary body is greater than that of the primary body over which it is formed. The secondary body imparts increased rigidity to the dental implement over the primary body.

### BACKGROUND OF THE INVENTION

1. Field of the Invention

The invention relates in general to dental implements, and more particularly, to a retaining device which is used to separate teeth and to hold a contour band in place around a tooth when a cavity in the tooth is to be filled or otherwise repaired.

2. Background Art

The use of retaining devices for holding contour bands is well known in the art. Typically, when tooth decay occurs near the outer edges of a tooth, there is often insufficient tooth structure remaining to support the filling material prior to hardening thereof. To overcome this problem, a thin band is positioned about the tooth and secured to the tooth to provide the required support for the filling material. In such a manner, the filling material can be positioned as desired, and can be formed into the desired shape.

To achieve the proper final desired shape, it is often necessary to separate the affected tooth from the immediately adjacent teeth. This is typically accomplished through the use of open ended rings having downwardly projecting tines, the ends of which are placed on opposing sides of the region between the affected tooth and an adjacent tooth which requires separation. One such structure is shown in U.S. Pat. No. 5, 607, 302 issued to Garrison et al, the entire specification of which is incorporated by reference. Use of such a device requires the separation of the opposing tines positioned at the ends of the open ended rings, and the positioning of the respective tines on opposing sides of the teeth. When released, the spring like nature of the ring provides an inward force against the tines which drives the tines toward each other. In turn, the teeth positioned between the tines generally are forced away from each other thereby increasing the gap between the two teeth. Over time, the rings tend to become plastically deformed, and the inward force exerted by the spring like nature of the ring decreases. Eventually, the spring force is reduced to such an extent that the device is no longer usable.

To overcome the losses in spring force, a number of solutions have been tried. One such solution is the use of a pre-stressed ring member, such that a greater number of repeated uses can be achieved. Such a solution is described in U.S. Pub. No. 2003/0148245 A1 published to Anderson.

Another solution has been the use of ring members which have a non uniform cross-sectional configuration, or which require great manipulation during formation. While such solutions offer increased rigidity and longevity, such solutions render devices which are expensive to produce and often difficult to produce. Thus, it would be advantageous to provide a dental implement which exhibits increased rigidity without the aforementioned drawbacks.

Another persistent problem is that the dental implement, in certain instances, undesirably shifts during utilization. This is typically due to the interface of the tines with a non planar and non uniform tooth surface. To preclude movement and dislodging of the dental implement, various modifications have been made to the tines. One such solution is shown in the aforementioned '302 patent wherein bulbous tips have been employed to enhance the engagement with the teeth. It would be advantageous to further enhance the securement of the tines relative to the opposing sides of the teeth of a patient by following the contours of the respective teeth.

Often it is necessary to utilize a number of such implements to repair a tooth (for example, a plurality of implements from a kit of implements having a plurality of differently sized implements). Implements of different sizes are provided such that the implements can be nested. One such nested use of implements is shown in the aforementioned '302 patent. Often, the differences between the different sizes is difficult to determine until the implement is already in the mouth of the patient. It would be advantageous if the relative sizing of each implement could be easily determined prior to utilization.

Thus, it is an object of the present invention to provide a dental implement which exhibits increased rigidity.

It is another object of the present invention to provide a dental implement which exhibits increased strength.

It is another object of the present invention to provide a dental implement which exhibits increased resilience.

It is another object of the present invention to provide a dental implement which enhances the engagement of teeth by the tines during use.

It is another object of the present invention to provide a manner in which to distinguish between a number of differently sized dental implements.

These objects as well as other objects of the present invention will become apparent in light of the present specification, claims, and drawings.

### SUMMARY OF THE INVENTION

The invention comprises a dental implement which overcomes the drawbacks of the prior art. In particular, the dental implement of the present invention comprises a primary body and a secondary body. The primary body includes a substantially planar ring shaped portion having opposing ends and a pair of tines extending in a downward direction from the opposing ends. The secondary body is formed over at least a portion of the primary body. The secondary body defines a cross-sectional area therealong. The cross-sectional area of the secondary body is greater than that of the primary body over which it is formed. The secondary body imparts increased rigidity to the dental implement over the primary body.

In a preferred embodiment, the secondary body comprises a polymer which is molded over a portion of the primary body.

In another preferred embodiment, the cross-sectional area of the secondary body is greatest at a section of the primary body opposite the portion having the opposing ends.

In another preferred embodiment, the second body includes a central region and opposing side regions. The central region has a cross-sectional area greater than that of the opposing side regions.

In one embodiment, the secondary body includes an upper surface and a lower surface. At least one of the upper surface and the lower surface includes at least one marking thereon.

In one such preferred embodiment, the at least one marking is molded into the respective upper surface and lower surface.

In another preferred embodiment, each of the tines includes a distal end that includes a bulbous tip.

Preferably, the primary body comprises a metal or an alloy thereof.

In a preferred embodiment, the ring shaped portion of the primary body includes a substantially uniform cross-sectional configuration.

In one such embodiment, the primary body includes a substantially uniform cross-sectional configuration.

In a preferred embodiment, at least one of the tines further includes a tine body having a first tooth engagement surface and a second engagement surface and an apex therebetween. The first tooth engagement surface is configured to follow the contours of a surface of a first tooth. The second tooth engagement surface is configured to follow the contours of a surface of a second tooth. The apex is positioned to extend toward the region between the first tooth and second tooth.

In a preferred embodiment, each of the first and second tooth engagement regions are outwardly concave.

In another preferred embodiment, each of the first and second tooth engagement regions are outwardly concave in multiple directions.

In another embodiment, the tine body can rotate relative to the remainder of the primary body.

In yet another embodiment, the tine body is formed over a portion of the primary body.

In another embodiment each of the tines includes a tine body.

In yet another preferred embodiment, the inner surface of the secondary body includes means for facilitating the spreading of the opposing ends of the ring shaped portion.

Preferably, the ring spreading means comprises a pair of opposing indentations positioned on either side of the secondary body spaced apart from the tines of the primary body.

In another aspect of the invention, the invention comprises a dental implement having a primary body. The primary body includes substantially planar ring shaped portion terminating in opposing downwardly extending tines. The ring shaped portion has a substantially uniform cross-sectional configuration. At least one of the tines further includes a tine body having a first tooth engagement surface and a second tooth engagement surface, and an apex therebetween. The first tooth engagement surface is configured to follow the contours of a surface of a first tooth. The second tooth engagement surface is configured to follow the contours of a surface of a second tooth. The apex is positioned to extend toward the region between the first tooth and second tooth.

In one embodiment, each of the first and second tooth engagement regions are outwardly concave.

In another embodiment, each of the first and second tooth engagement regions are outwardly concave in multiple directions.

In another embodiment, the tine body can rotate relative to the remainder of the primary body.

In yet another embodiment, the body is formed over a portion of the primary body.

In yet another aspect of the invention, the invention comprises a kit having at least two differently sized dental implements. Each dental implement comprises a primary body and a secondary body. The primary body includes a substantially planar ring shaped portion having opposing ends and a pair of tines extending in a downward direction from the opposing ends. The secondary body is formed over at least a portion of the primary body. The secondary body defines a cross-sectional area. The cross-sectional area of the secondary body is greater than that of the primary body over which it is formed. The secondary body imparts increased rigidity to the dental implement over the primary body. Each of the differently sized dental implements are distinguished through one of a marking imparted on the secondary body and a color of the secondary body.

In a preferred embodiment, the marking imparted on the secondary body comprises a marking molded into at least one of the upper surface and the lower surface of the secondary body.

### BRIEF DESCRIPTION OF THE DRAWINGS

The invention will now be described with reference to the drawings wherein:

FIG. 1 of the drawings comprises a perspective view of a dental implement of the present invention;

FIG. 2 of the drawings comprises a top plan view of the dental implement of the present invention;

FIG. 3 of the drawings comprises a front elevational view of the dental implement of the present invention;

FIG. 4 of the drawings comprises a cross-sectional view of dental implement of the present invention, taken generally about lines 4-4 of FIG. 3, and alternate cross-sectional configurations are shown in FIGS. 4a through 4d;

FIG. 5 of the drawings comprises a top plan view of an embodiment of the dental implement of the present invention;

FIG. 6 of the drawings comprises a top plan view of an embodiment of the dental implement of the present invention;

FIG. 7 of the drawings comprises a top plan view of an embodiment of the dental implement of the present invention, showing, in particular, the tine bodies;

FIG. 8 of the drawings comprises a partial side elevational view of the tine body of an embodiment of the dental implement of the present invention;

FIG. 9 of the drawings comprises a partial cross-sectional view of the tine body of an embodiment of the dental implement of the present invention taken generally about lines 9-9 of FIG. 7; and

FIG. 10 of the drawings comprises a top plan view of a plurality of dental implements of the present invention shown in an operative position within a mouth of a patient.

### DETAILED DESCRIPTION OF THE DRAWINGS

While this invention is susceptible of embodiment in many different forms, there is shown in the drawings and described herein in detail specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

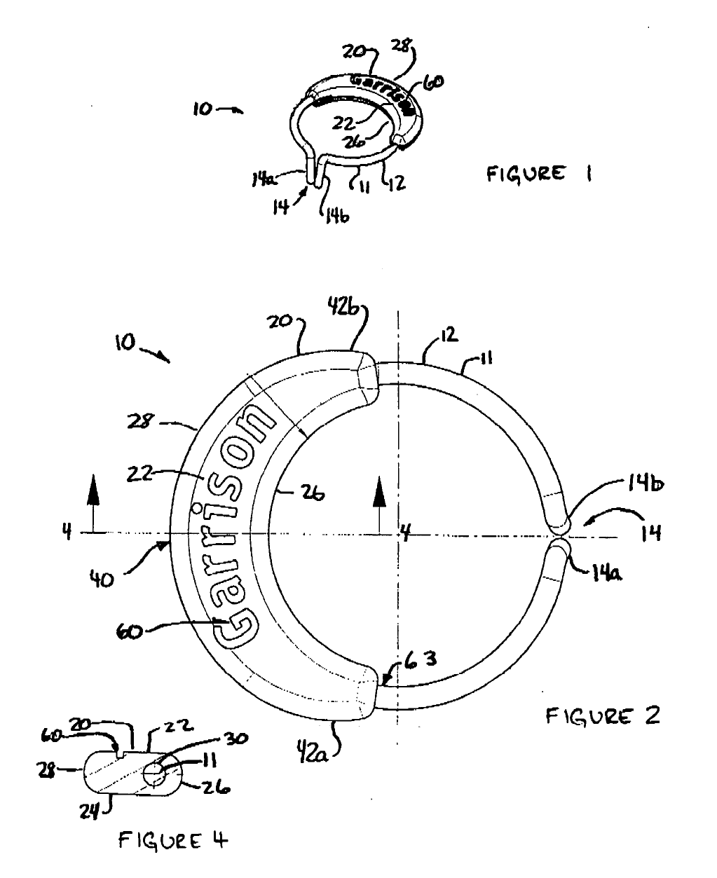

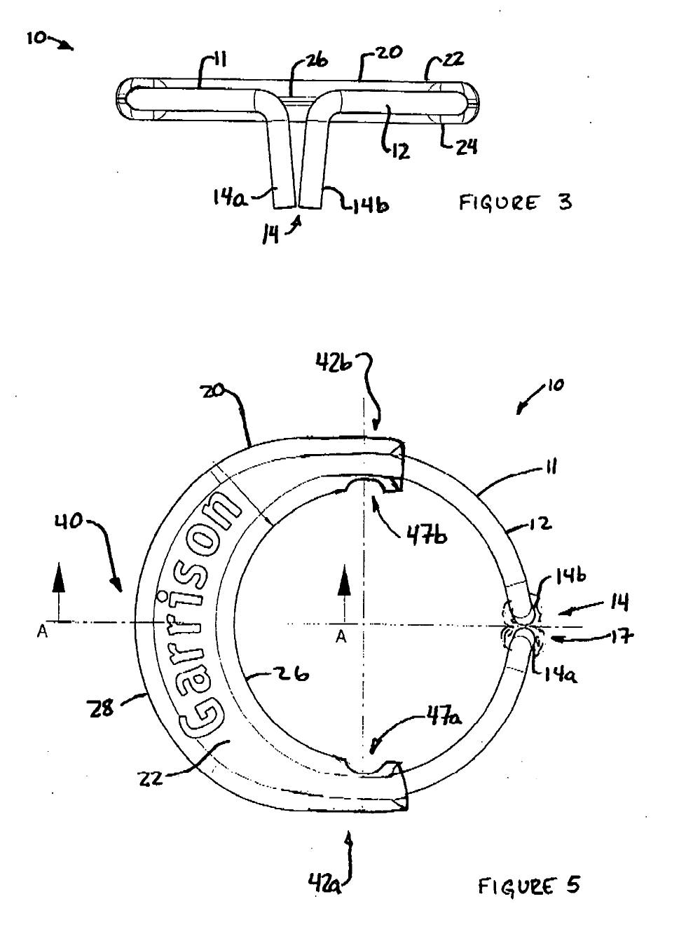

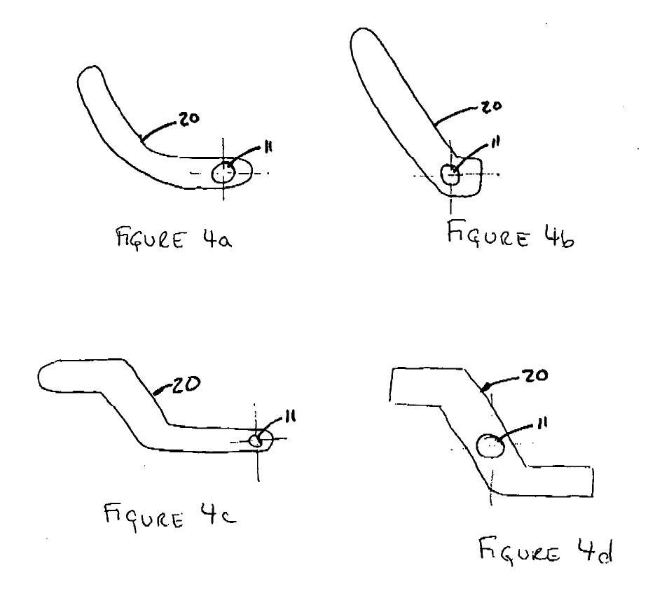

Referring now to the drawings and in particular to FIGS. 1 and 2, the dental implement is shown generally at 10. The dental implement is typically configured for separating adjoining teeth and for retaining a band or matrix against a tooth undergoing repair. The dental implement includes primary body 11 and secondary body 20, with the secondary body formed over at least a portion of the primary body. Primary body 11 includes ring shaped portion 12 having opposing ends and prongs (commonly referred to as tines) 14a, 14b which extend in a generally downward direction from the opposing ends of the ring shaped portion. The distal ends of the opposing tines generally approach each other so that they are positioned closer to each other than the proximal ends of the opposing tines. In certain embodiments the tines may contact each other or may cross each other.

Typically, the ring shaped portion has a diameter of approximately 0.675″ to 0.825″ and the prongs have a length of approximately 0.270″ to 0.370″. Of course, the invention is not limited to such sizes. The ring shaped portion is generally planar with the prongs extending in a downward direction at an angle relative to the plane defined by the ring shaped portion.

The ring shaped portion and the prongs are typically formed from a single integrated member. Typically, the primary body is formed from an extruded wire such as stainless steel spring wire. Of course, other materials, such as titanium or titanium alloys are contemplated, as are other metals and alloys thereof. In most configurations, the cross-sectional configuration of the primary body is circular, elliptical, rectangular, among others. While certainly not required, the cross-sectional configuration of the ring shaped portion is substantially uniform.

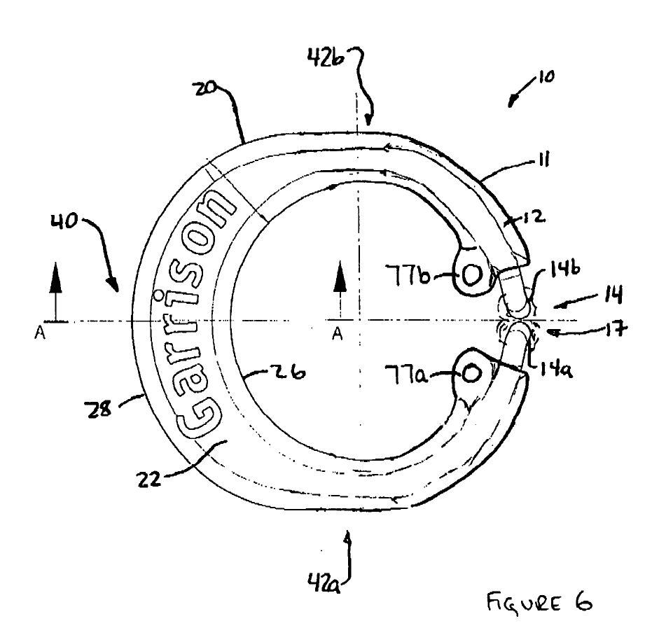

In certain embodiments, as is shown in FIG. 5, bulbous tips 17 may be incorporated into the distal ends of the tines so as to foster retention in a desired configuration. One such construction of the tines is shown in U.S. Pat. No. 5,607,302 issued to Garrison et al, the entire specification of which is incorporated by reference. In other embodiments, different configurations for the tines is likewise contemplated.

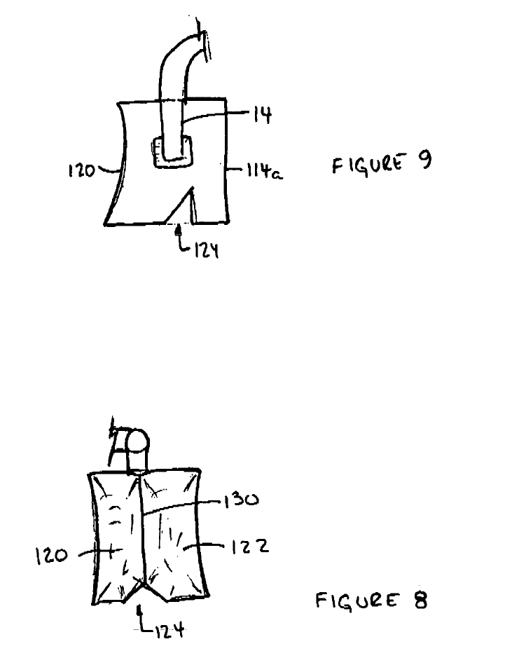

With reference to FIGS. 7 through 9, a tine body 114 may be employed in association with tines 14. Specifically, tine body 114a will be described with the understanding that tine body 114b is substantially a mirror image thereof, in concept and operation (while it may be slightly different in shape). Tine body 114a is formed over the underlying tine 14. Tine body 114a includes first tooth engagement surface 120, second tooth engagement surface 122 and dental wedge region 124. The first and second tooth engagement surfaces 122, 124 extend on either side of apex 130. Each of the engagement surfaces include an outwardly concave configuration which extends in two dimensions (i.e., resulting in a dish-line configuration). Such a concave configuration increases contact of the tooth engagement surfaces with the corresponding tooth of the patient. Apex 130 is substantially vertical when the implement is properly positioned, so as to follow the space between the two respective teeth.

Apex 130 and the portions of the tooth engagement surfaces immediately adjacent to the apex, on either side thereof, define an angle α To properly foster the spreading of the teeth contacted by the tooth engagement surfaces, angle α is preferably less than 150°, and most preferably less than 100°. Of course, the particular angles will vary depending on whether the tine is on the outside of the tooth or on the inside of the tooth, and will also depend on the particular application (i.e., adult, child, etc.).

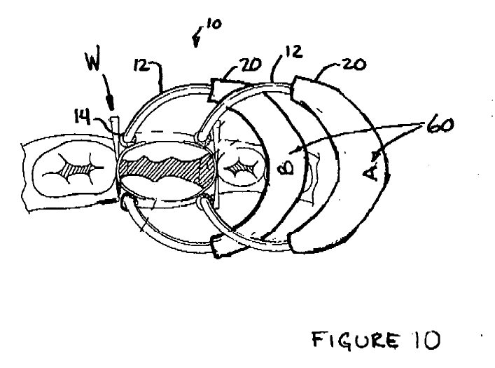

To facilitate the use of dental wedges and other implements between the two teeth which are to be spread by the dental implement (such as the use of wedge W in FIG. 10), a slot may extend transverse to the longitudinal axis of the tine, and through apex 130. As such, a dental practitioner can extend a wedge along the slot in the tine body and between the teeth while maximizing the contact between the tooth and the tooth engagement surfaces. In the embodiment shown, the slot has a substantially triangular cross-section, whereas in other embodiments, such a cross-section may be varied.

In certain embodiments, the tine bodies 114 may be formed over to the underlying tine 14 and fixed relative thereto. In other embodiments, tine bodies 114 may be configured to rotate about the axis of the underlying tine so as to provide further manipulation, to, in turn, maximize the surface contact with the teeth of the patient. In still other embodiments, tine bodies 114 may be connected to the secondary body so as to comprise a single integrated member which covers substantially the entirety of the underlying primary body.

To form the tine bodies 114, it is contemplated that the individual tines may be cut from an extruded member into the required length, at which time, an opening is extended therethrough for insertion of tine 14. In other embodiments, the extrusion may be curved as it is extruded so as to achieve the desired concave configuration in the direction of the extrusion. Of course, other methods of manufacturing, such as molding individual tines onto primary bodies sequentially is likewise contemplated for use.

Secondary body 20, shown in FIGS. 2 and 4, is formed over at least a portion of the ring shaped portion 12 of primary body 11. The secondary body includes upper surface 22, lower surface 24, inner surface 26, outer surface 28 and internal cavity 30. When molded, the ring shaped portion 12 defines, and fills, internal cavity 30 of the secondary body. The cross-sectional configuration of the secondary body is generally rectangular. Preferably, the secondary body lies in the same plane as the ring portion of the primary body. Of course, the two bodies may lie in planes that are parallel or that intersect each other. Additionally, the upper and lower surfaces of the secondary body are shown as being substantially planar, it is contemplated that any number of different structural shapes are contemplated, which in turn yields any one of a number of different cross-sectional areas (elliptical, rectangular, square, arcuate, arbitrary, etc.). Certain contemplated cross-sectional areas are shown in FIGS. 4a through 4d.

Among other purposes the secondary body provides increased strength, resilience and/or rigidity to the dental implement. To achieve the same, the cross-sectional area of the secondary body is generally greater than the cross-sectional area of the ring shaped portion to which the secondary body is molded. With reference to FIG. 2, the secondary body includes a central portion 40 and opposing side portions 42a, 42b. The central portion corresponds to a position on the ring shaped portion that is opposite tines 14. The opposing side portions taper to a decreased cross-sectional area. At the extreme opposing ends of the secondary body, the ring shaped portion protrudes from the internal cavity of the secondary body, and the cross-sectional area of the secondary body may be approximately twice that of the ring shaped portion. Proximate the central region, however, the cross-sectional area of the secondary body may be well in excess of multiples of that of the ring shaped portion. The invention is not limited to any particular increase in the cross-sectional area of the secondary body relative to the primary body over which any portion of the secondary body is formed. Thus, the increased rigidity, strength and resilience can be achieved through the use of the secondary body, and without altering the cross-sectional configuration of the primary body. Of course, in certain embodiments, it may be desirable to utilize a primary body of a non-uniform cross-section.

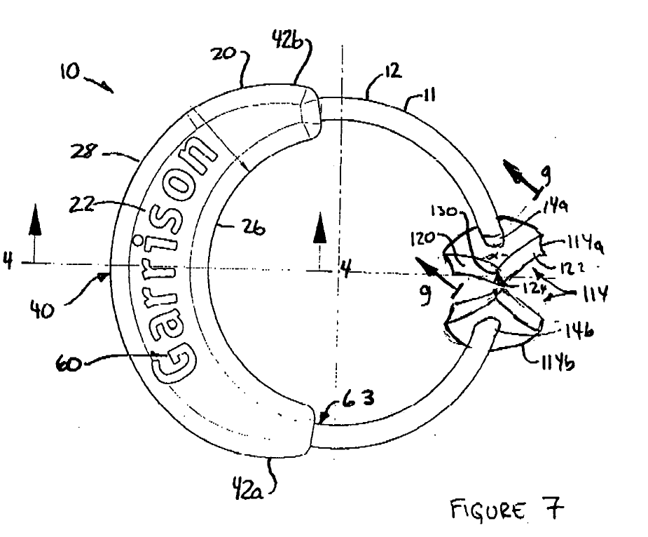

In certain embodiments, as is shown in FIG. 5, the inner surface of the secondary body may include a means for facilitating the spreading of the ring. In the embodiment shown, opposing indentations, such as indentations 47a, 47b configured for the receipt of the ends of the separating jaws or pliers that are typically utilized with such dental implements. Indeed, the indentations preclude inadvertent sliding or rotating of the dental implement relative to the separating jaws or pliers. In other embodiments, such as the embodiment shown in FIG. 6, opposing openings 77a, 77b may be formed from one of the upper surface and the lower surface into the secondary body, or through the secondary body to provide a means by which to spread the ring. In other embodiments, the jaws or pliers can be interfaced proximate ridge 63 (FIG. 2) defined at the opposing terminations of the secondary body.

Preferably, the secondary body is molded over the primary body and comprises a polymer material which is suitable for repeated use without failure and which is suitable for undergoing an autoclaving process as well as other sterilization processes. One such material comprises a Nylon material available from DuPont under the trade name Zytel 408 HS. Of course, the invention is not limited to such a material. Indeed, a number of moldable (castable) materials may be suitable for use.

With reference to FIG. 10, it is often desirable to utilize differently sized and shaped dental implements in with a particular procedure. One such use of combinations of dental implements is shown in the aforementioned '302 patent. In such a procedure, the dental implements can be nested relative to each other. To nest, however, differently sized dental implements are utilized. To distinguish between differently sized and shaped dental implements differently colored secondary bodies can be utilized. Inasmuch as the secondary body generally comprises a polymer material, the color of the secondary bodies can be easily altered.

Furthermore, the secondary body can carry additional identification markings, such as markings 60, on either or both of the upper surface and the lower surface of the secondary body. In the embodiment shown in FIG. 2, indicia corresponding to the manufacturer is molded into the upper surface of the secondary body. In other embodiments, a size reference or other marking may be incorporated into this surface. It is contemplated that a number of differently sized dental implements can be provided as part of a kit or assembly.

To manufacture the dental implement, the primary body is first formed from a metal material. Typically, the metal material is formed into a straight rod shaped member (i.e., through extrusion or other forming). Subsequently, the member is plastically deformed so as to form the desired ring shaped portion, and, the prongs.

Once formed, a mechanical process may be applied to the tines so as to form the bulbous tips. In other embodiments, a coating or other material may be applied over the tips of the tines so as to form the bulbous tips. It is likewise contemplated that the bulbous tips may be added after the formation of the secondary body.

Once the primary body is formed, the primary body is placed into a mold wherein the secondary body is molded over at least a portion of the primary body. In the embodiment shown, the secondary body is molded over approximately 170° of the primary body. The secondary body is generally centered about the primary body at a point opposite of the tines. It is contemplated that multiple secondary bodies may be molded over portions of the ring portion. It is likewise contemplated that the secondary body may encompass a portion of the primary body which is greater or less than 170°. For example, and with reference to FIG. 6, the secondary body extends over well in excess of 170° of the primary body.

The mold may impart surface markings onto any one of the surfaces of the secondary body, for purposes of size identification, manufacturer identification, among other identification. Additionally, size identification can be accomplished through the use of differently colored materials for the formation of the secondary body.

Advantageously, the dental implement of the present invention provides an increased rigidity over a substantially uniform primary body while allowing for the use of a substantially uniform metal member from which to form the primary body. Furthermore, the secondary body provides an improved means by which to grasp and identify the dental implement through the use of different colors and through the use of markings on the secondary body.

The foregoing description merely explains and illustrates the invention and the invention is not limited thereto except insofar as the appended claims are so limited, as those skilled in the art who have the disclosure before them will be able to make modifications without departing from the scope of the invention.

What is claimed:

1. A dental implement comprising:
a primary body having a substantially planar ring shaped portion having opposing ends, and a pair of tines extending downward from the opposing ends; and
a secondary body formed over at least a portion of the primary body, the secondary body defining a cross-sectional area therealong, the cross-sectional area of the secondary body being greater than that of the primary body over which it is formed.

2. The dental implement of claim 1 wherein the secondary body comprises a polymer which is molded over a portion of the primary body.

3. The dental implement of claim 1 wherein the cross-sectional area of the secondary body is greatest at a section of the primary body opposite the portion having the opposing ends.

4. The dental implement of claim 3 wherein the second body includes a central region and opposing side regions, wherein the central region has a cross-sectional area greater than that of the opposing side regions.

5. The dental implement of claim 1 wherein the secondary body includes an upper surface and a lower surface, at least one of the upper surface and the lower surface includes at least one marking thereon.

6. The dental implement of claim 5 wherein the at least one marking is molded into the respective upper surface and lower surface.

7. The dental implement of claim 1 wherein each of the tines includes a distal end that includes a bulbous tip.

8. The dental implement of claim 1 wherein the primary body comprises a metal or an alloy thereof.

9. The dental implement of claim 1 wherein the ring shaped portion of the primary body includes a substantially uniform cross-sectional configuration.

10. The dental implement of claim 9 wherein the primary body includes a substantially uniform cross-sectional configuration.

11. The dental implement of claim 1 wherein at least one of the tines further includes:
a body having a first tooth engagement surface and a second tooth engagement surface, and an apex therebetween, the first tooth engagement surface configured to follow the contours of a surface a first tooth, the second tooth engagement surface configured to follow the contours of a surface of a second tooth, and the apex positioned to extend toward the region between the first tooth and second tooth.

12. The dental implement of claim 11 wherein each of the first and second tooth engagement regions are outwardly concave.

13. The dental implement of claim 12 wherein each of the first and second tooth engagement regions are outwardly concave in multiple directions.

14. The dental implement of claim 11 wherein the body can rotate relative to the remainder of the primary body.

15. The dental implement of claim 11 wherein the body is formed over a portion of the primary body.

16. The dental implement of claim 1 wherein each of the tines further includes:
a body having a first tooth engagement surface and a second tooth engagement surface, and an apex therebetween, the first tooth engagement surface configured to follow the contours of a surface a first tooth, the second tooth engagement surface configured to follow the contours of a surface of a second tooth, and the apex positioned to extend toward the region between the first tooth and second tooth.

17. The dental implement of claim 1 wherein the inner surface of the secondary body includes means for facilitating the spreading of the opposing ends of the ring shaped portion.

18. The dental implement of claim 17 wherein the ring spreading means comprises one of a pair of opposing indentations and openings which are positioned on either side of the secondary body spaced apart from the tines of the primary body.

19. A dental implement comprising:
a primary body including a substantially planar ring shaped portion terminating in opposing downwardly extending tines, the ring shaped portion having a substantially uniform cross-sectional configuration;
at least one of the tines further includes:
a body having a first tooth engagement surface and a second tooth engagement surface, and an apex therebetween, the first tooth engagement surface configured to follow the contours of a surface a first tooth, the second tooth engagement surface configured to follow the contours of a surface of a second tooth, and the apex positioned to extend toward the region between the first tooth and second tooth.

20. The dental implement of claim 19 wherein each of the first and second tooth engagement regions are outwardly concave.

21. The dental implement of claim 20 wherein each of the first and second tooth engagement regions are outwardly concave in multiple directions.

22. The dental implement of claim 19 wherein the body can rotate relative to the remainder of the primary body.

23. The dental implement of claim 19 wherein the body is formed over a portion of the primary body.

24. The dental implement of claim 19 wherein each of the tines further includes:
a body having a first tooth engagement surface and a second tooth engagement surface, and an apex therebetween, the first tooth engagement surface configured to follow the contours of a surface a first tooth, the second tooth engagement surface configured to follow the contours of a surface of a second tooth, and the apex positioned to extend toward the region between the first tooth and second tooth.

25. A kit comprising a plurality of dental implements having at least two differently sized dental implements, each dental implement comprising:
a primary body having a substantially planar ring shaped portion having opposing ends, and a pair of tines extending downward from the opposing ends; and
a secondary body formed over at least a portion of the primary body, the secondary body defining a cross-sectional area, the cross-sectional area of the secondary body being greater than that of the primary body over which it is formed, to, in turn, impart an increased rigidity thereto,
wherein each the differently sized dental implements are distinguished through one of a marking imparted on the secondary body and a color of the secondary body.

26. The kit according to claim 25 wherein the marking imparted on the secondary body comprises a marking molded into at least one of the upper surface and the lower surface of the secondary body.

27. The dental implement of claim 25 wherein at least one of the tines further includes:
a body having a first tooth engagement surface and a second tooth engagement surface, and an apex therebetween, the first tooth engagement surface configured to follow the contours of a surface a first tooth, the second tooth engagement surface configured to follow the contours of a surface of a second tooth, and the apex positioned to extend toward the region between the first tooth and second tooth.
